(19) United States
(12) Patent Application Publication
(10) Pub. No.: US 2010/0116411 A1
(43) Pub. Date: May 13, 2010

(54) CONTINUAL MANUFACTURING PROCESS FOR SWABS

(76) Inventor: CHIH-PING WEI, Tainan Country (TW)

Correspondence Address: J C PATENTS, 4 VENTURE, SUITE 250, IRVINE, CA, 92618, US

(21) Appl. No.: 12/270,794

(22) Filed: Nov. 13, 2008

(51) Int. Cl. B32B 37/06

(52) U.S. Cl. 156/73.2

(57) ABSTRACT

A continual manufacturing process includes steps of preparing a combined band consisting of two-layers of material sheets and plural swab sticks having their heads sandwiched orderly between the two layers of material sheets, a step of placing the combined sheet together with the sticks and moved on the table by a conveying roller to pass between a roller-type knife mold and a supersonic vibrating head to let the roller-type knife mold press a part of the two layers at the head of each stick, and a step of cutting the part of the material sheets at the head of each stick by means of punch knives of the roller-type knife mold and of being heated by the roller-type knife mold to soften and to be adhered to the head of each stick to make finished swabs.

### BACKGROUND OF THE INVENTION

1. Field of the Invention

This invention relates to a continual manufacturing process for swabs, particularly to one utilizing a roller-type knife mold making continual rolling action in conjunction with a supersonic vibrating head vibrating at high speed, so the heads of plural sticks laid in a two-layer material sheet may be cut together with a part of the two-layer material sheet by the mold-shaped knives of the roller-type knife mold one by one and immediately heated to become soft and adhered with the heads of the sticks, with the head material cut off at two sides and adhered together at the same time, achieving automatic mass production of swabs.

2. Description of the Prior Art

Swabs are widely used in the field of hygiene, medication, nursing, electronic components, cosmetics, etc. Conventional swabs are generally made of sticks of wood, bamboo, plastics, etc., and one end of the stick is firstly coated with glue, and a tiny cotton ball is adhered with the glue, finishing a conventional swab. In using, the cotton ball of conventional swabs sometimes may have its tiny cotton lines hooked or pulled, and if worse, falls off the stick, damaged in its function. Provided the cotton ball of the swab should be used to daub a chemical solution or alcohol, the glue of the cotton ball might melt to lose its viscosity, permitting the cotton ball fall off the stick, losing its usefulness. In view of the drawbacks, makers now use chemical fiber, foam cotton or sponge instead of natural cotton for a swab head by means of supersonic vibrating process as an improving measure.

However, the supersonic vibrating process used nowadays is to place a material sheet on a supersonic vibrating head firstly, plural swab sticks are arranged orderly to place their heads on the material sheet, and then another material sheet is covered on the stick heads just on the lower material sheet. Then a flat mold with plural punch knives is pressed down the parts of the material sheets sandwiching the sticks heads, cutting two sides of the parts to let each part of the material sheet attached on each stick head, and then melted to adhere to the stick head. After that, the mold is moved up, and the finished swabs are taken off and cleaned, with the remaining material sheets removed. Thus, this conventional manufacturing process for swabs is repeated manually in plural stages of operation, so its production is quite slow and inconvenient. Moreover, in cutting the two sides of the part of the material sheet and melting, the operation has to be stopped temporarily, impossible to continue manufacturing. Besides, the width of the mold is restricted by the size of the supersonic vibrating head, so if a wider swab head is needed, the number of the mold-shaped knives has to be reduced, resulting in less production. Therefore, this conventional process is not suitable for mass production of swabs. Thus those flaws are to be improved.

### SUMMARY OF THE INVENTION

This invention has been devised to offer a continual manufacturing process for swabs, by using a combined band consisting of two-layers of material sheets for the heads of sticks orderly arranged between the two layers of material sheets in two rows, and the process is carried out by equipment consisting of the following.

A table is used for placing the combined band thereon; a conveying roller is installed on the table for moving the combined band on the table; a roller-type mold is installed on the table and in front of the conveying roller and provided plural punch knives equidistantly spaced apart on its annular circumference; a supersonic vibrating head is installed under the table and facing the roller-type mold for producing heat to the roller-type mold

Then the continual manufacturing process includes a step of laying the combined band together with the sticks in two rows on the table, a step of starting the conveying roller to rotate to move the combined band together with the sticks along the table to pass between the roller-type mold and the supersonic vibrating head so that the punch knives may continually cut a part of the two layers of material sheets with the head of each stick and the part is heated by the roller-type mold to become and soft and adhere to the head of each stick to become a finished swab.

Thus swabs are manufactured continually and quickly.

### BRIEF DESCRIPTION OF DRAWINGS

This invention will be better understood by referring to the accompanied drawing, wherein:

FIG. 1 is a schematic view of devices used in continual manufacturing process for swabs in the present invention;

FIG. 2 is an upper view of swabs formed by a combined band passing a roller-type mold in the continual manufacturing process for swabs in the present invention;

FIG. 3 is a side view of the roller-type mold in the present invention; and

FIG. 4 is a side view of a roller-type mold with larger punch knives in the present invention.

### DETAILED DESCRIPTION OF THE PREFERRED EMBODIMENT

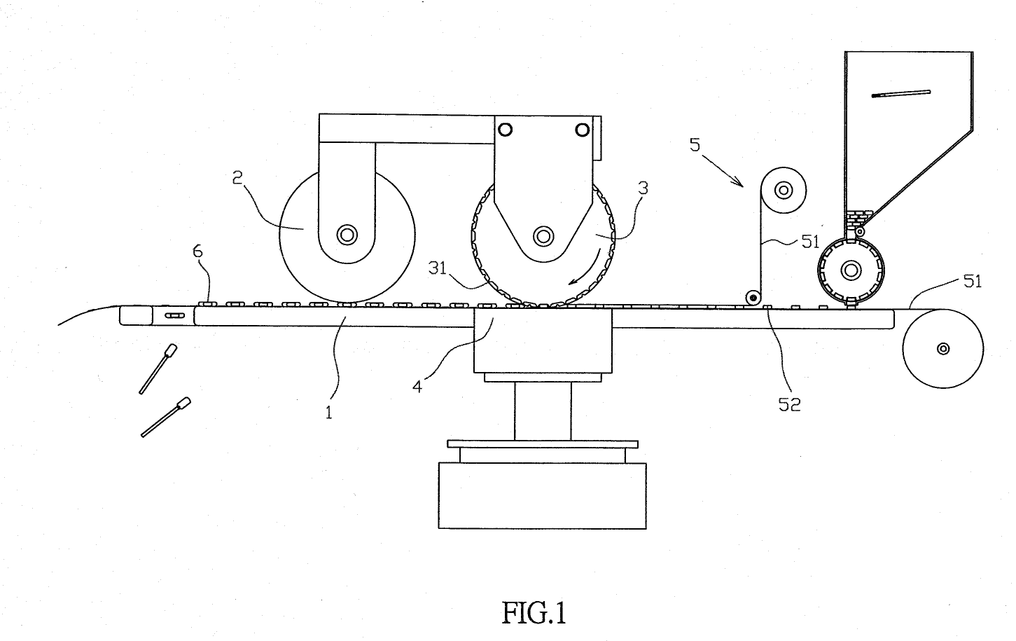

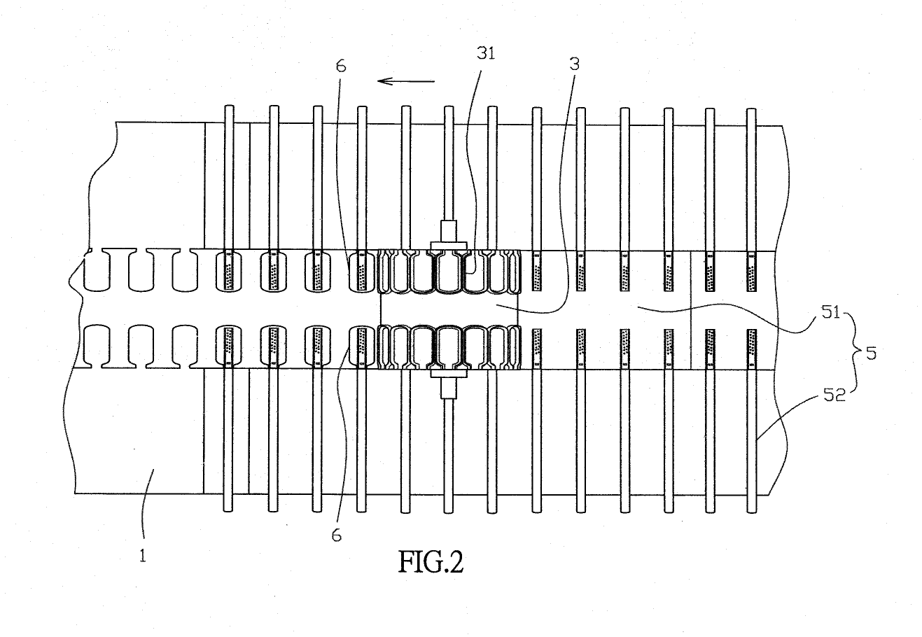

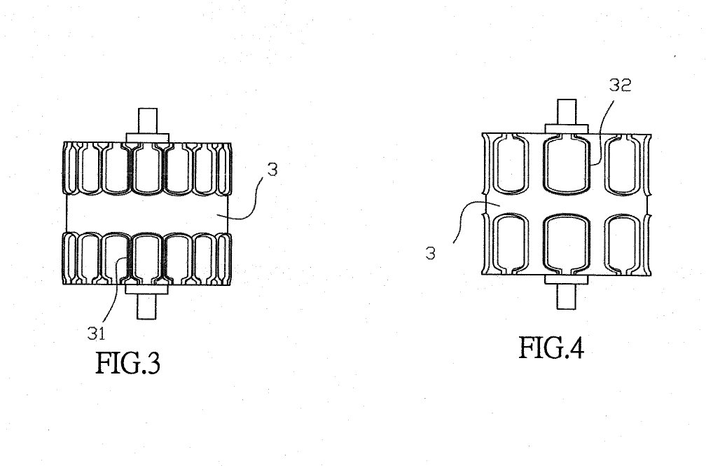

A continual manufacturing process for swabs in the present invention, as shown in FIGS. 1, 2 and 3, uses a table 1, a conveying roller 2, a roller-type knife mold 3, a supersonic vibrating head 4, and a combined band 5 consisting of two-layers of material sheets 51 for swab heads and the heads plural swab sticks 52 laid between the two layers orderly arranged.

The table 1 is used to place the combined band 5 thereon.

The conveying roller 2 is installed on the table 1 to convey the combined band on the table I by its rotation.

The roller-type knife mold 3 is installed on the table 1 in front of the conveying roller 2, connected with the convention roller 2 in parallel to move with the convening roller 2 synchronously and provided with plural punch knives 31 spaced apart equidistantly on the annular circumference.

The supersonic vibrating head 4 is positioned under the table 1 and facing to the lower end of the roller-type knife mold 3, having its upper side flush with the surface of the table 1 so as to produce and give heat to the roller-type knife mold 3.

The combined band 5 consists of the two layers of material sheets 51 and the heads of plural swab sticks 52 sandwiched equidistantly spaced apart between the two layers of material sheet 51.

The continual manufacturing process for swabs includes a first step that the conveying roller 2 is rotated to move the combined band 5 together with the swab sticks 52 placed on the table 1 to pass between the roller-type mold 3 and the supersonic vibrating head 4. Then a second step of the process is continually to press and heat the combined band 5 by the roller-type knife mold 3 and to punch and cut two sides of a part of the two layers of material sheets 51 just on and under the head of each stick 52 with the mold-shaped knives 31 so that the cut off part of the combined material sheet 51 may become soft and adhere to the head of each stick 52. Then a third step of the process is to seal up the cut two sides of the material part on and under the head of each stick 52, which then becomes a finished swab 6 with a head of the material. At last, a fourth step of the process is to pick up and clean the finished swabs 6 after passed over the conveying roller 2 and the remaining waste of the material sheet 51 is collected to be recycled.

Next, as shown in FIG. 4, the mold-shaped knives 31 of the roller-type knife mold 3 can be of any size or shape, and the mold 3 is also not restricted in its size, and subsequently the number of the punch knives is not limited, either. Therefore, different sized swabs 6 can be made easily by forming punch knives 31 of different sizes on the roller-type knife mold 3.

Moreover, the roller-type knife mold 3 is installed to move synchronously with the conveying roller 2, facilitating operation of pressing and punching the combined band 5.

While the preferred embodiment of the invention has been described, it will be recognized and understood that various modifications may be made therein and the appended claims are intended to cover all such modifications that may fall within the spirit and scope of the invention.

What is claimed is:

1. A continual manufacturing process for swabs using a two-layer material sheet consisting of a two layers of material sheets with heads of plural swab sticks sandwiched equidistantly spaced apart between said two layers and using equipment comprising:
a table for placing said two-layers of material sheets together with said swab sticks on its surface;
a conveying roller installed to let its lower end flush with a surface of said table, rotated to move said two-layers of material sheet together with said swab sticks on said table;
a roller-type knife mold installed to let its lower end flush with the surface of said table, having plural punch knives equidistantly spaced apart around its annular circumference;
a supersonic vibrating head installed under said table and located just under said roller-type knife mold so as to produce heat that is to be transmitted to said roller-type mold for heating said two layers of material sheets; and
said continual manufacturing process including a step of moving said two-layers of material sheets together with said swab sticks to move on said table and pass between said roller-type knife mold and said supersonic vibrating head, a second step of said roller-type knife mold rolling and pressing said combined band and of said supersonic vibrating head heating said combined band, a third step of said mold-shaped knives of said roller-type mold punching to cut two sides of a part of said two layers of material sheets at a head of each said swab stick sandwiched in said material sheets and said part fused together by said roller-type knife mold and adhere to the head of each said swab stick to become a finished swab, a fourth step of picking up and cleaning said finished swabs and removing remaining waste of said material sheet from said table.

2. The continual manufacturing process as claimed in claim 1, wherein said supersonic vibrating head has its upper side flush with a surface of said table.

3. The continual manufacturing process as claimed in claim 1, wherein said punch knives of said roller-type knife mold are of any size and shape.

4. The continual manufacturing process as claimed in claim 1, wherein said roller-type knife mold moves synchronously with said conveying roller.

5. The continual manufacturing process as claimed in claim 1, wherein said roller-type knife mold and said supersonic vibrating head are located in front of said conveying roller.
